(19) United States
(12) Patent Application Publication
(10) Pub. No.: US 2014/0327645 A1
(43) Pub. Date: Nov. 6, 2014

(54) TOUCHSCREEN ACCESSORY ATTACHMENT

(71) Applicant: NOKIA CORPORATION, Espoo (FI)

(72) Inventors: Andrew Peter MATTHEWS, Grantchester (GB); Darryl Paul James Cotton, St. Ives (GB)

(73) Assignee: Nokia Corporation, Espoo (FI)

(21) Appl. No.: 13/887,584

(22) Filed: May 6, 2013

(51) Int. Cl. G06F 3/044

(52) U.S. Cl. CPC G06F 3/044
USPC 345/174

(57) ABSTRACT

An apparatus including a capacitive touch input device (TID); and a controller connected to the capacitive touch input device. The controller is configured to process a user touch signal from the capacitive touch input device. The controller is configured to process a non-touch signal from the capacitive touch input device generated by an electrical coupling of a device to the capacitive touch input device, where the non-touch signal is a variable signal.

### BACKGROUND

1. Technical Field

The exemplary and non-limiting embodiments relate generally to a touch input device and, more particularly, to a capacitive touch input device.

2. Brief Description of Prior Developments

Capacitive touch screen technology is now commonplace on devices such as smartphones, tablets and other consumer electronics devices for example. There are a variety of capacitive touch screen panel designs, some using single layer conductive films, while others use two or more layers. Some capacitive touch screen technologies are beginning to be integrated into the display layers (coupled into the OLED and LCD structures) themselves. However, all capacitive touch panels and touch screen technologies work by projecting a capacitive field into free space beyond the boundary set by the display cover (glass or plastic), and either measuring the change in capacitive coupling between a transmitter and receiver electrode (mutually capacitive) or measuring the capacitance to ground between a single electrode and a finger (self-capacitive).

### SUMMARY

The following summary is merely intended to be exemplary. The summary is not intended to limit the scope of the claims.

In accordance with one aspect, an example apparatus includes a capacitive touch input device (TID); and a controller connected to the capacitive touch input device. The controller is configured to process a user touch signal from the capacitive touch input device. The controller is configured to process a non-touch signal from the capacitive touch input device generated by an electrical coupling of a device to the capacitive touch input device, where the non-touch signal is a variable signal.

In accordance with another aspect, an example method comprises providing an apparatus with a capacitive touch input device (TID); and connecting a controller to the capacitive touch input device, where the controller is configured to process a user touch signal from the capacitive touch input device, and where the controller is configured to process a non-touch signal from the capacitive touch input device based upon an electrical coupling of a device to the capacitive touch input device, and where the controller is configured to process the non-touch signal as the signal varies.

In accordance with another aspect, an example embodiment comprises a non-transitory program storage device readable by a machine, tangibly embodying a program of instructions executable by the machine for performing operations, the operations comprising processing a first user' touch signal from a capacitive touch input device (TID) a first way; and processing a second device generated signal from the capacitive touch input device a second different way, where the processing of the second signal is configured to process a change in the second signal.

In accordance with another aspect, an example method comprises connecting an accessory device to an apparatus, where the apparatus comprises a capacitive touch input device (TID), where the accessory device is located on the capacitive touch input device; and generating a signal from the capacitive touch input device based upon a wireless signal being generated by the accessory device, where the wireless signal varies over time.

In accordance with another aspect, an example apparatus comprises a body; a plurality of electrodes on the body, where the body is configured to be placed on a capacitive touch input device (TID) to locate the electrodes against the capacitive touch input device; and electrical circuitry on the body which is connected to at least one of the electrodes, where the apparatus is configured to send a signal from the electrical circuitry, which is variable in time, to the capacitive touch input device by a wireless coupling of the at least one electrode with the capacitive touch input device.

### BRIEF DESCRIPTION OF THE DRAWINGS

The foregoing aspects and other features are explained in the following description, taken in connection with the accompanying drawings, wherein:

FIG. 1 is a front view of an apparatus comprising features as described herein;

FIG. 2 is a diagram illustrating some of the components of the apparatus shown in FIG. 1;

FIG. 3 is a diagram illustrating a device to be used with the apparatus shown in FIG. 1;

FIG. 4 is a diagram illustrating an apparatus comprising the apparatus of FIG. 1 and the device of FIG. 3;

FIG. 5 is a diagram illustrating a first coupling between the apparatus and device shown in FIG. 4;

FIG. 6 is a second coupling between the apparatus and device shown in FIG. 4;

FIG. 7 is a diagram illustrating example components of the device shown in FIG. 3;

FIG. 8 is a diagram illustrating another example of components of the device shown in FIG. 3;

FIGS. 9A and 9B are diagrams illustrating an alignment;

FIG. 10 is a diagram of an example electrode layout;

FIG. 11 is a picture of the electrode layout of FIG. 10 on a substrate attached to an apparatus;

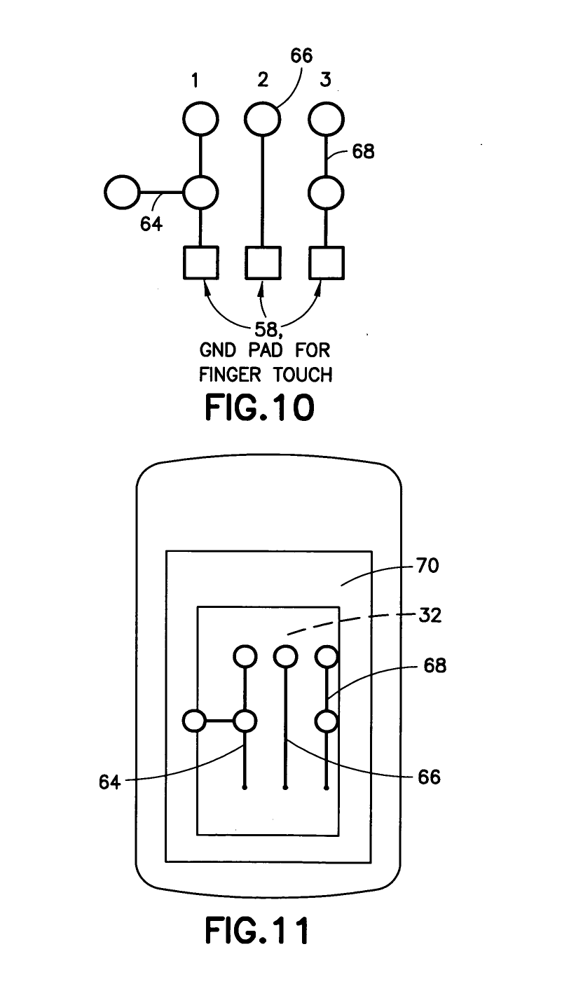

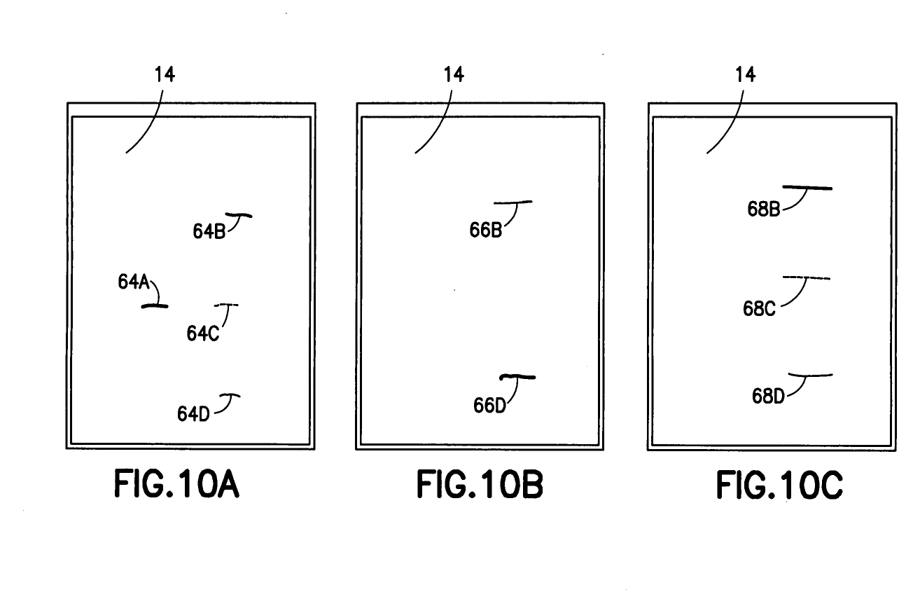

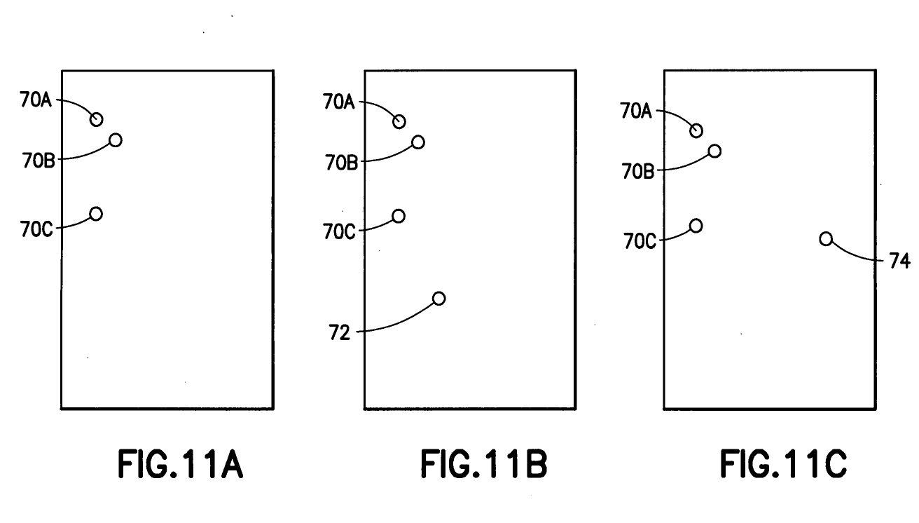

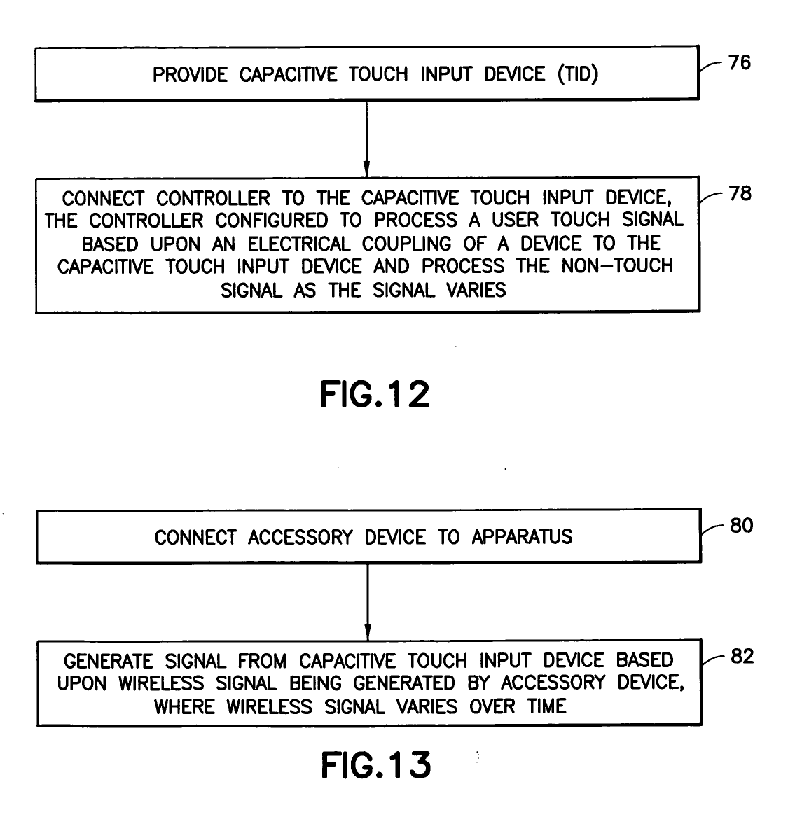

FIGS. 10A-10C illustrate sensed simulated touch events using the electrode layout shown in FIGS. 10-11;

FIGS. 11A-11C illustrate how signals from the device may change over time;

FIG. 12 illustrates some steps of an example method; and

FIG. 13 illustrates some steps of an example method.

### DETAILED DESCRIPTION OF EMBODIMENTS

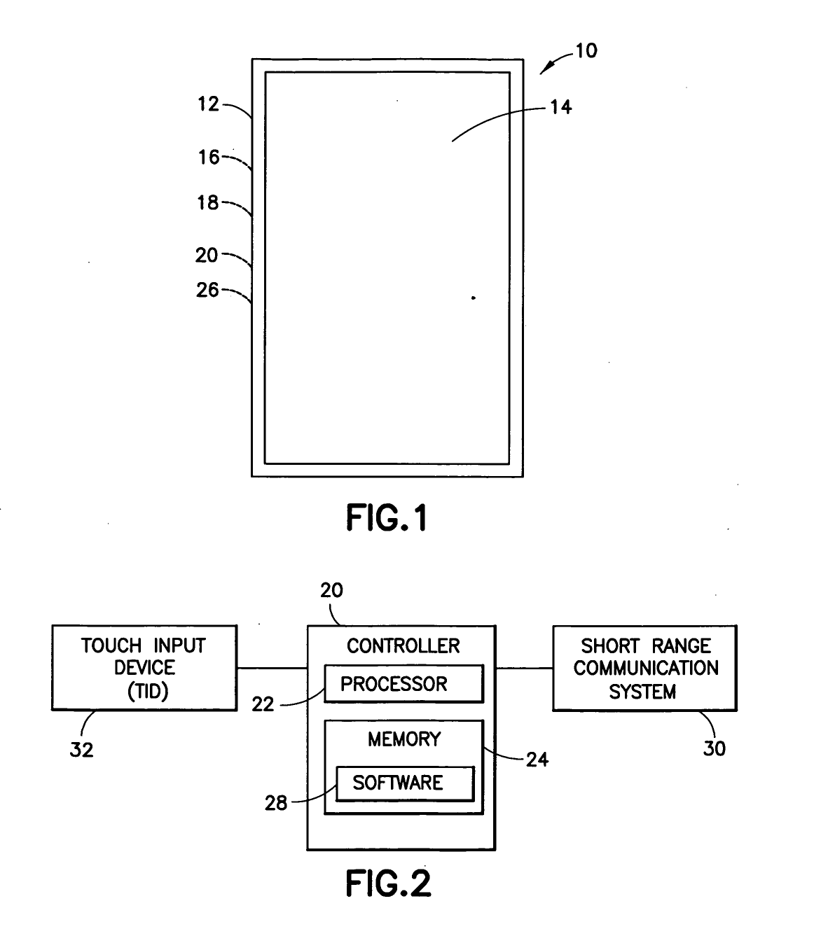

Referring to FIG. 1, there is shown a front view of an apparatus 10 incorporating features of an example embodiment. Although the features will be described with reference to the example embodiments shown in the drawings, it should be understood that features can be embodied in many alternate forms of embodiments. In addition, any suitable size, shape or type of elements or materials could be used.

The apparatus 10 may be a hand-held communications device which includes a telephone application. The apparatus 10 may additionally or alternatively comprise an Internet browser application, camera application, video recorder application, music player and recorder application, email application, navigation application, gaming application, and/or any other suitable electronic device application. Referring to both FIGS. 1 and 2, the apparatus 10, in this example embodiment, comprises a housing 12, a display 14, a receiver 16, a transmitter 18, a rechargeable battery 26, and a controller 20 which can include at least one processor 22, at least one memory 24, and software 28. However, all of these features are not necessary to implement the features described below.

The display 14 in this example is a capacitive touchscreen display which functions as both a display screen and as a user input. The user interface may also include a keypad or other user input device. The electronic circuitry inside the housing 12 may comprise a printed wiring board (PWB) having components such as the controller 20 thereon. The circuitry may include a sound transducer provided as a microphone and a one or more sound transducers provided as an earpiece and/or speaker.

The receiver 16 and transmitter 18 form a primary communications system to allow the apparatus 10 to communicate with a wireless telephone system, such as a mobile telephone base station for example. As shown in FIG. 2, in addition to the primary communications system 16, 18, the apparatus 10 may also comprises one or more short range communications system 30. This short range communications system 30 comprises an antenna, a transmitter and a receiver for wireless radio frequency communications. Examples of the short range communication system 30 include BLUETOOTH, RFID and/or NFC for example.

The apparatus 10 comprises a touch input device (TID) 32 which, in this example, is part of the capacitive touch screen 14. However, in alternate example embodiments the touch input device (TID) might not be part of an electronic display, such as a touch pad for example. The touch input device (TID) 32 is a capacitive touch input device. When a user presses on the touchscreen 14 with a finger (or at least comes close to the touchscreen 14 with the finger), the touch input device (TID) 32 is configured to output a signal to the controller 20 to signal the touch event on the touch input device to the controller 20, such as the location of touch event on the touch input device (TID) 32.

Mobile smartphones and tablet computers commonly have capacitive touch screens, or panels. While the designs of the touch panel electrodes vary, and some panels require shields to reduce cross-talk between the panel and the display, all touch panels and touch screens are designed to propagate an electromagnetic field to or beyond the borders of the panel and/or display cover window into free space. The algorithms that are implemented in the touch panel integrated circuit (IC) are designed to measure the change in capacitive coupling between a set of electrodes and objects (fingers, hands, etc.) that approach or touch the screen. Typically the capacitive field emanated by the electrodes of the touch panel is non-linear over the entire surface of the screen and, hence, each sensor uses a calibration curve to linearize the output with respect to location of touch. Equally, the magnitude of the projected field varies over time due to drift in the electronics, and hence time variant AC projected fields are used and most measurements are relative. Further, the algorithms contained in the driver chips are also able to compensate for “shadowing”, which occurs when extraneous objects come close to the screen and potentially obscure the desired reading. An example of this might be the capacitive image created by the palm of a hand while inputting key-strokes using a thumb.

Hence, capacitive touch screens are sophisticated devices capable of producing a projected field and measuring changes in the field associated with localized changes in the conductivity of the space into which the field propagates. The calibrated output of these sensors is typically provided as a location and number of touch points, represented by spatial coordinates relative to the dimensions of the display.

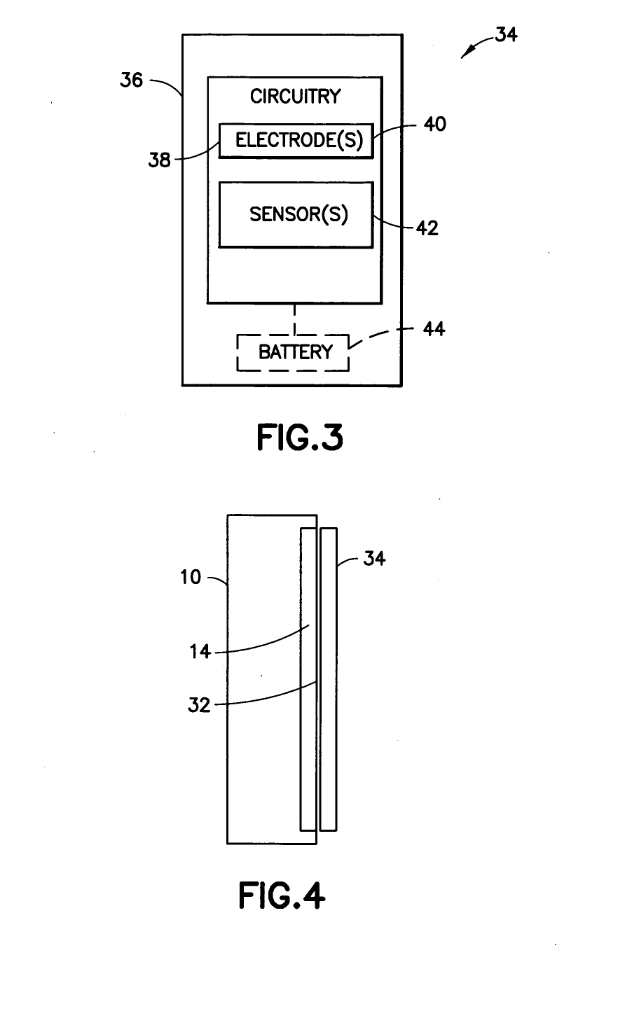

Referring also to FIG. 3, there is shown a diagram of a device 34 which is adapted to be used with the apparatus 10; perhaps as an accessory device or add-on device. The device 34 comprises a body 36 and electrical circuitry 38 on the body 36. The electrical circuitry 38 comprises electrodes 40 and at least one functioning component 42. In this example the functioning component 42 may be, or may comprise, one or more sensors. The device 34 may comprise a battery 44. However, in some example embodiments the device might not comprise a battery. This device 34 is hereinafter referred to also as a remote sensing element (RSE).

Referring also to FIG. 4, the device 34 is configured to be connected to the apparatus 10 to form a new type of apparatus. In particular, the device 34 is configured to be located on the exterior facing side of the touchscreen 14. Any suitable means may be used to mount the device 34 to the apparatus 10. In some instances the device 34 may merely be placed on top of the touchscreen and held in place by gravity, such as when the apparatus 10 is lying down. By placing the device 34 on the touchscreen 14, the device 34 is placed in the operational range of the capacitive touch input device (TID) 32.

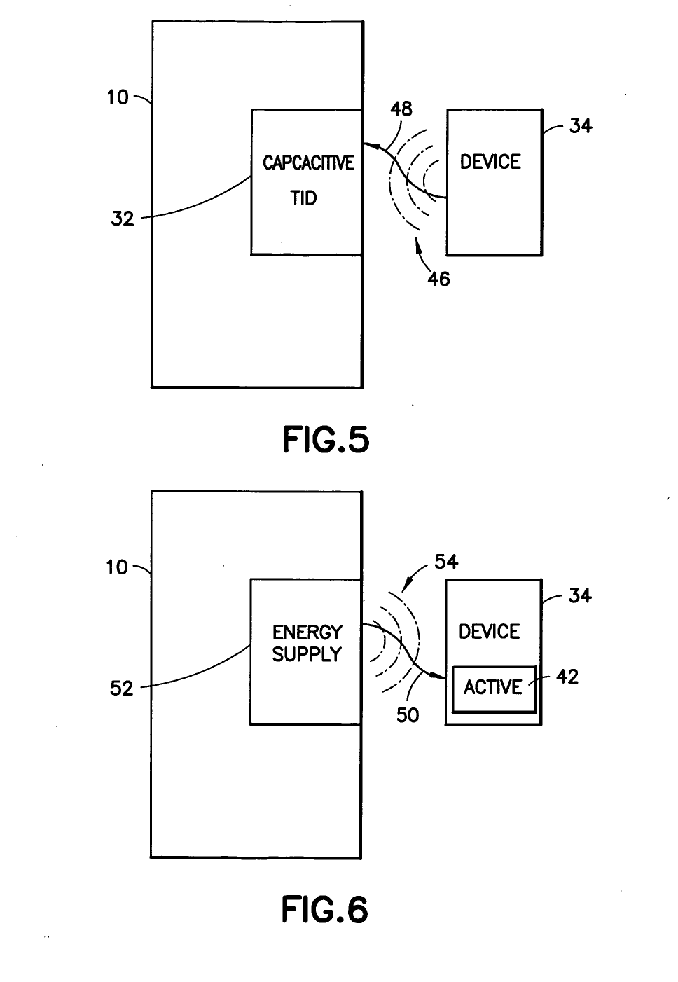

Referring also to FIG. 5, a schematic diagram illustrating a feature of this example is shown. The device 34 is adapted to generate a wireless electrical signal 46 to form an electrical coupling 48 to the capacitive touch input device 32. In particular, with reference to FIG. 3, the circuitry 38 is configured to cause the electrodes 40 to be sensed by the capacitive touch input device 32. For example, the circuitry and electrodes may be configured to modulate the electromagnetic field which may be sensed by the capacitive touch input device 32. The circuitry 38 may have the electrodes 40 modulate or generate the electromagnetic field (to be sensed by the TID 32) based upon a signal from the functioning component 42 (such as a sensor for example). Thus, the capacitive touch input device 32 may be used as both an input to sense user touch, and as an effective IN port into the apparatus 10 for the device 34. Thus, information from the device 34 may be input into the apparatus 10 using the capacitive touch input device 32 as an I/O input port; other than for user touch.

As smartphone and tablet usage has increased, so has the desire to use mobile devices for more than telephony, video consumption and internet access. Increasingly, sensors are being integrated into mobile devices to provide data such as concerning device usage, environmental factors and motion for example. However, the addition of sensors to mobile devices is complex; requiring significant development effort and additional cost. Features as described herein may be used to change this industry-wide constraint and utilize the existing capacitive touch sensor technology to enable a new stream of sensor capabilities and revenue streams, without necessitating any substantive hardware changes.

Mobile telephones, tablets and laptops (devices) are increasingly being carried continuously by users throughout their waking lives. This consistent usage means that the devices are becoming an invaluable tool for monitoring health, the environment and other variable factors that impact users' lives. There is, therefore, an increasing desire to add sensors to mobile devices for a variety of purposes.

Typically most mobile device sensors are integrated in the device and measure external influences. Examples include antennae that sense the ambient radio and microwave fields propagating through space, MEMS devices that measure linear and/or angular accelerations, barometers that measure ambient pressure and magnetometers that measure the earth's magnetic field. Other sensors measure human interaction with the device. Examples of such sensors include proximity sensors to detect whether the device is pressed to someone's ear as they make a call, and touch sensors that detect user touches on the surface of the device. Each of these sensors performs a very specific task and requires calibration, linearization and integration with the device, either as part of the operating system or through the system architectural requirements including communications bus lines, input/output (I/O) ports, interrupt protocols and other signal processing requirements.

Integrating new sensors, therefore, requires that the Operating System (OS) can accommodate the sensor, that there are sufficient bus lines and I/O ports, and that the correct software and hardware is available to take the measurement, calibrate it, and convert it into standard formats for subsequent interpretation by an application or program. Since device hardware tends to be manufacturer, OS and device-specific, implementing a novel sensing technology capable of use by a broad number of devices is highly complex, takes considerable time and resources, and requires access to new sensors and supporting technologies.

Mobile device usage is also moving forward rapidly, and software service development is significantly constrained by platform (hardware) availability (in volume) and consequentially business viability. There is, therefore, a mismatch in the service provision capability and hardware availability.

As illustrated by the example described above, a means to overcome this industry-wide tension is to leverage an existing sensor that is commonly available (e.g. a capacitive touch panel 14) and use this sensor to create a sensing platform capable of performing a wide variety of sensing tasks by wirelessly coupling an external sensor(s) such as on the device 34, or other input device, to this common sensing platform; the TID 32.

Referring also to FIG. 6, features as described herein may use an existing sensor or wireless source on a mobile device 10 to provide energy 50, by capacitive or inductive coupling, to a remote sensor 42 in the device 34. In the example shown, the device 10 comprises an energy supply 52 which is configured to induce a varying magnetic field 54 to induce current in a coil in the device 34. Thus, the device 34 may be powered by induction from the apparatus 10. The apparatus 10 may supply power to the device 34 and/or record the derived sensor data output from the device 34 by capacitive coupling, using the touch sensor 32 provided on the mobile device 10. Thus, the device 34 does not necessarily need the battery 44.

In one type of embodiment the RSE does not incorporate a battery or other energy storage device, but obtains its energy directly from energy sources associated with the mobile device or from chemical interactions that take place on the RSE during the measurement process.

One such mobile energy source is the capacitive touch sensor itself. While the instantaneous energy emitted by the capacitive touch sensor is relatively small, it is sufficient to read the RSE. In such cases, the sensor may not require electrical energy to conduct the measurement, but only requires energy to read the results of the measurement. If the measurement process requires more energy than is available by capacitively coupling the RSE to the touch sensor, even using a capacitor or supercapacitor on the RSE to store the received charge over a period of time, then alternative energy sources on the mobile device could be used. Examples of wireless energy sources might include:
Bluetooth (including extended range and extended data rate and low energy variants)
Near Field Communications (NFC)
WiFi
2/2.5/2.75/3/4G
LTE
Any other wireless radio or microwave channel

In order to convert the high frequency electromagnetic energy into useful energy to make the desired measurement on the RSE, one or more antennae would need to be incorporated into the RSE. These antennae can readily be created using printable ink, thin wire or other construction processes similar to those used in the RFID industry. The advantage offered by this is that the RSE is not dependent on a particular wireless communications protocol and, hence, needs no complex electronics to interpret the transmitted wireless signals. Rather, the RSE is only intercepting the wireless signal to generate electricity in the circuits of the RSE to perform a measurement. Hence, the measurement is not constrained by compatibility issues or standards, rather the efficiency of the wireless antennae and the availability of given wireless signals, which of course can be controlled by the user.

Equally, it would also be possible to power a remote sensing element using a wired connection to the mobile device. In this instance, the most commonly available and standard power source on mobile devices would be the speaker (headphone) output jack. Some mobile devices also allow charging from their USB ports. Either way, the electrical output signals could be converted to usable measurement energy by relatively simple circuits. It is preferred that the energy required to drive the measurement is provided wirelessly, but wired options are included in this application for completeness.

BLUETOOTH, RFID and/or NFC may be used to power and read remote sensors. However, each of these approaches requires dedicated radio communications with standards compatibility, necessitating dedicated signal processors on the Remote Sensing Element (RSE). Many such devices are not backwardly compatible even with earlier versions of the same protocol. Features as described herein may use to create a sophisticated sensing platform that is not constrained by any standards and that can be operated by the vast majority of all touchscreen mobile devices.

With features as described herein, a capacitive touch sensor (such as typically provided on mobile devices, including mobile phones, smartphones, tablets, laptops and other portable form factor computing devices) may be used to generate measurements made on a Remote Sensing Element (RSE), such as 34, by capacitively reading the output of the Remote Sensing Element (RSE) using the mobile device's capacitive touch sensor. Such measurements may be generated on the Remote Sensing Element (RSE) chemically, optically, electrically or by other means. The Remote Sensing Element (RSE) may be powered from the mobile device by one or more means, or by means of a chemical reaction, or by power supplied by the Remote Sensing Element (RSE) itself. The Remote Sensing Element (RSE) may be configured to convert an interaction of a measurand, with a sensor of the Remote Sensing Element (RSE), to a measurable change in the capacitive properties of the remote sensing element, such that the change may be read wirelessly by the standard mobile device capacitive touch sensor. Such changes in the capacitive properties may include one or more of the following interactions:
A change in the number of measurable touch locations
A change in the separation of two or more touch locations, possibly one or more of the touch locations being a reference location
A change in the location of one or more touch locations during the period of the measurement
A change in the capacitive coupling between the touch sensor and the RSE in one or more locations caused either by a change in the dielectric properties or impedance of the RSE circuits
A change in the capacitive coupling between the touch sensor and the RSE caused by a change in area or shape of the region affected by the measurand

In one example, the Remote Sensing Element (RSE) is manufactured using printing techniques and is of extremely low cost. Dependent on the measurement process, the RSE may or may not require electric power to execute one measurement. If the RSE requires power, this may be supplied either wirelessly by the mobile device or directly by the RSE itself, through on-board energy storage or generation devices including batteries, capacitors, supercapacitors or some form of energy harvesting.

A feature as described herein is to utilize a capability to read a remote sensor, that can be placed in the region of and coupled to a capacitive touch input device (TID), such that the output of the remote sensor can be read as a change in the capacitive coupling of the of the remote sensor (RSE) to the TID. This minimizes the read-out electronics required on the remote sensing element (RSE) and minimizes the cost of such remote sensors by reducing or entirely eliminating the need for them to provide their own energy source.

As indicated above, the sensor result is transduced into a change in the location, number or coupling of capacitive elements on the RSE. The exact mechanism by which the change in capacitance, impedance, or inductance is induced in the RSE sensor is may be designed as needed so long as there is transductance and a method of reading the same using the mobile device's capacitive touch input device (TID).

An example method as described herein encompasses the use of a sensor (RSE) whose properties are modified by the interaction with a substance to be measured (measurand) that is coupled to the mobile device through a capacitive touchscreen. The RSE may be provided as a partially planar remote sensing element. The RSE may comprise either one or more conductive or dielectric structures designed to couple energy to and/or from a capacitive touch screen. The RSE may be able, either through chemical reaction or an electrical process, to measure the effect of the interaction between a substance and the remote sensing element. Such substances may include gases, liquids or solids. The interaction might be assisted with physical interaction by the user, by an energy storage device, by chemical reaction or by energy imparted in the RSE by the mobile device or other external power source.

Passive Electrode Design

For a passive electrode design, conducting electrodes may be positioned in an array on the RSE. These electrodes may or may not be electrically linked to a common grounding electrode through interconnects, and some or all of the interconnects may be exposed to the measurand in the sensing region. This region (the region of the RSE to be exposed to the measurand) may comprise one or more sensing media and structures designed to change the impedance, capacitance or inductance of one or more of the interconnects.

By changing the impedance or capacitance of the interconnects to this prefabricated patterned array of electrodes, one or more of the following interactions may be detected by a standard touch panel:
By virtue of a threshold measurement of capacitance, initially none, one, several or all of the electrodes may be detectable by the touchscreen. However, as the impedance or capacitance of the interconnects change, one or more of the electrodes will be detected or will become undetectable. This may be recorded as a shift in location of the apparent touch point for panels only capable of measuring a single touch point, or the addition or subtraction of one or more apparent touch points on panels capable of detecting multi-touch. The presence or otherwise of the measurand can thereby be determined by the apparent shift in touch location, or the addition or subtraction of perceived touch points.
By virtue of a threshold measurement of capacitance, initially none, one, several or all of the electrodes may be detectable by the touch screen. However, as the impedance of the interconnects change, one or more of the electrodes will gradually become detectable or undetectable. This may be recorded as a time-dependent shift in location of the apparent touch point for panels only capable of measuring a single touch point, or the time-dependent addition or subtraction of one or more apparent touch points on panels capable of detecting multi-touch. The presence or otherwise, or concentration of the measurand may thereby be determined by the speed in apparent shift in touch location or addition or subtraction of perceived touch points. Speed may be measured as a function of position and time.
If additional touch sensor data can be obtained, beyond a simple Go/No-Go threshold measurement, then the magnitude of the capacitive coupling may be measured, which may allow the shape and area of the apparent touch location to be determined.

In one embodiment, a user's finger provides the ground to the circuit so that, when the sensor is placed on top of a capacitive touch screen, the electrodes which are electrically connected to the finger ground (through the sensing media switch) may be detected by the capacitive touch screen. The remaining electrodes may be subsequently invisible to the capacitive touch screen so long as their overall size is small enough not to act as a charge reservoir (dependent upon the threshold levels of the touch screen).

In another example embodiment, where the mobile device touch sensor measures mutual inductance, each of the electrodes may be connected to the mobile earth, or ground through the touch panel electrodes, and the RSE electrodes are not electrically interconnected.

In the simplest embodiment, the sensing region may act as a switch; making one or more electrodes detectable by the touch panel. However, because this approach has no reference by which the user might ascertain whether or not the measurement has actually taken place or is accurate, in example embodiments relative measurements of capacitance with respect to one or more of the passive electrodes may be made. In this instance, a reference electrode may be provided whose measured capacitance will not be affected by the measurement process, and which will therefore act as a stable measured location. The presence, concentration or otherwise of the measurand can, therefore, be detected as a change in the measured capacitance, or apparent touch locations, with respect to the initial reference capacitance. The reference electrode may be connected directly to the grounding finger or remotely through the touch panel to confirm that the device is sufficiently well contacted to the touch screen and to determine the level of acceptability or adequacy of the measurement process.

Furthermore, multiple sensing regions may be implemented using either similar or different sensing media to vary the impedance or capacitance of a number of interconnects in such a way that either a single measurement is made repeatedly (in order to minimize the possibility of false-positives/negatives and improve the quality of the measurement), or single measurements are made using different sensing criteria to determine more complex measurements. By way of example, separate sensing regions and interconnects may be used either to analyze the measurand by both capacitive and impedance changes in different interconnects. For example, one interconnect may be caused to increase in impedance as a result of one interaction with a specific sensing media, while a separate interconnect might incorporate a capacitive element whose capacitance is varied by the interaction of the same measurand with a different sensing media. Alternatively, different sensing media may be used on separate interconnects to measure different elemental or compound interactions with different sensing media to change either the inductance or capacitance of the interconnects, in a process to determine the correct composition of a complex measurand for which one media capable of executing the measurement does not exist. In this case multiple parallel measurements may be made in order to determine the correct composition of the measurand. Alternatively, different sensing media could be used to sense multiple inputs. To sense an input the switch only has to change state for example to ON from OFF or OFF to ON. Furthermore, each of the sensing regions could have a different degree of sensitivity to the sensed media. For example a humidity sensor may trigger switch 1 if there is 10% humidity, and may trigger switches 1 and 2 if there is 20% humidity.

The relative position, number of electrodes, and timing may then be interpreted by an “App”, or program, on the mobile device to output the touch sensor information in a more meaningful manner, such as the presence or otherwise of the measurand. The “App” or program may also be used to provide advice to the user, or direct the user to a relevant source of information, such as web site (using the mobile device to affect the connection). The “App” or program may also store the data and provide statistics to the user of a number of inputs or time.

With features as described herein, the device may combine a pre-printed passive electrode structure, which is visible when it is electrically connected to a sufficiently large charge reservoir/gnd and does not require further calibration or enhancements of the capacitive touch panel.

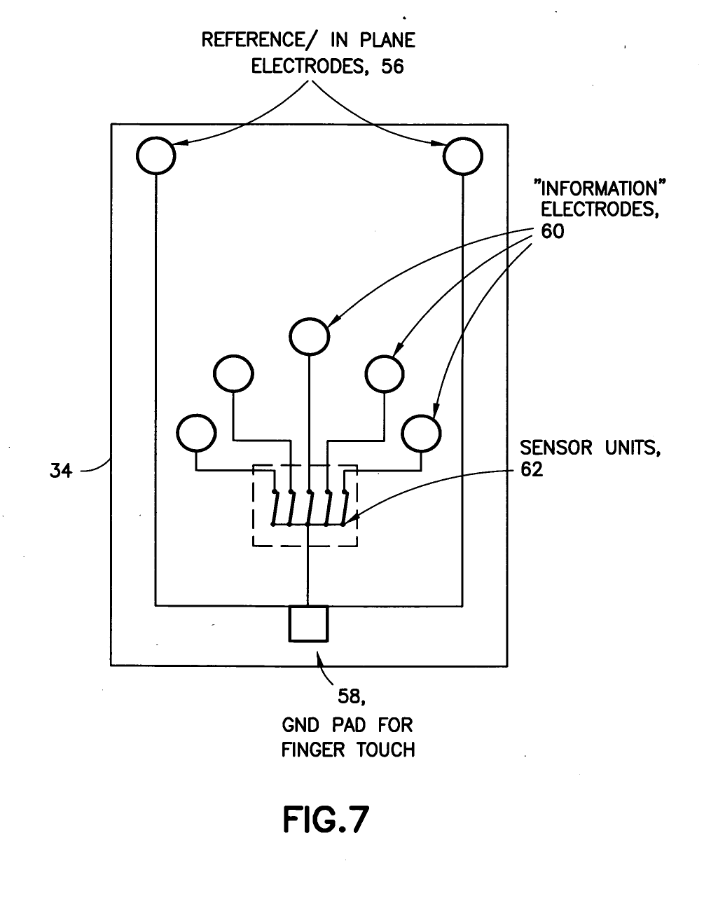

FIG. 7 shows a plan view diagram of an example sensor system on the device 34. The system consists of two reference electrodes 56 electrically connected to an exposed ground pad 58, and an array of “information” electrodes 60 which are also electrically connected to the ground pad 58 through the sensing regions 62, represented schematically as switches. It should be obvious from the above description that the illustrated switches represent regions of the interconnects that change capacitance, impedance or inductance based on the change induced by exposure to the measurand, and that this schematic is only representative of such structures and shown for simplicity.

In general, the electrodes 56, 58 can only be seen by the capacitive touch panel 32 if the electrodes have a sufficient ground and are, therefore, required to be activated by an electrical connection to a finger (or other charge reservoir). In this example the reference electrodes 56 are always electrically connected to the ground pad 58, and may be used to indicate to the apparatus 10 when the device 34 has been placed on the touch panel 32 (artificially simulating when a finger is placed on the capacitive touch panel 32).

The reference electrodes 56 and the ground pad 58 may ensure that the device 34 is laid correctly on the exterior surface of the touch panel 32 (or at least the orientation of the device 34 on the touch panel 32 is read correctly by the apparatus 10). Three points define a plane, so in this example a minimum of two reference electrodes 56 and a ground electrode 58 are required to show that the device 34 is correctly positioned on the touchscreen 14. This layout may enable the device 34 to be orientated in any direction/orientation on the screen 14; as the position of the “information” electrode nodes 60 may be taken relative to the reference electrodes 56, 58. The relative position of the reference electrodes 56 may also be used to identify the sensor type e.g. humidity, blood test etc., in a manner similar to the prior art disclosed. For example, a first type of device for sensing a first measurand may have its orientation reference electrodes 56, 58 located in different locations relative to each other versus a second different type of device for sensing a second different measurand. The apparatus 10 may be configured to identify which type of sensor device is located on the touchscreen based upon the locations of the orientation electrodes 56, 58 relative to each other. The apparatus 10 may be programmed to process signals from the device differently based upon which type of device the apparatus 10 has identified.

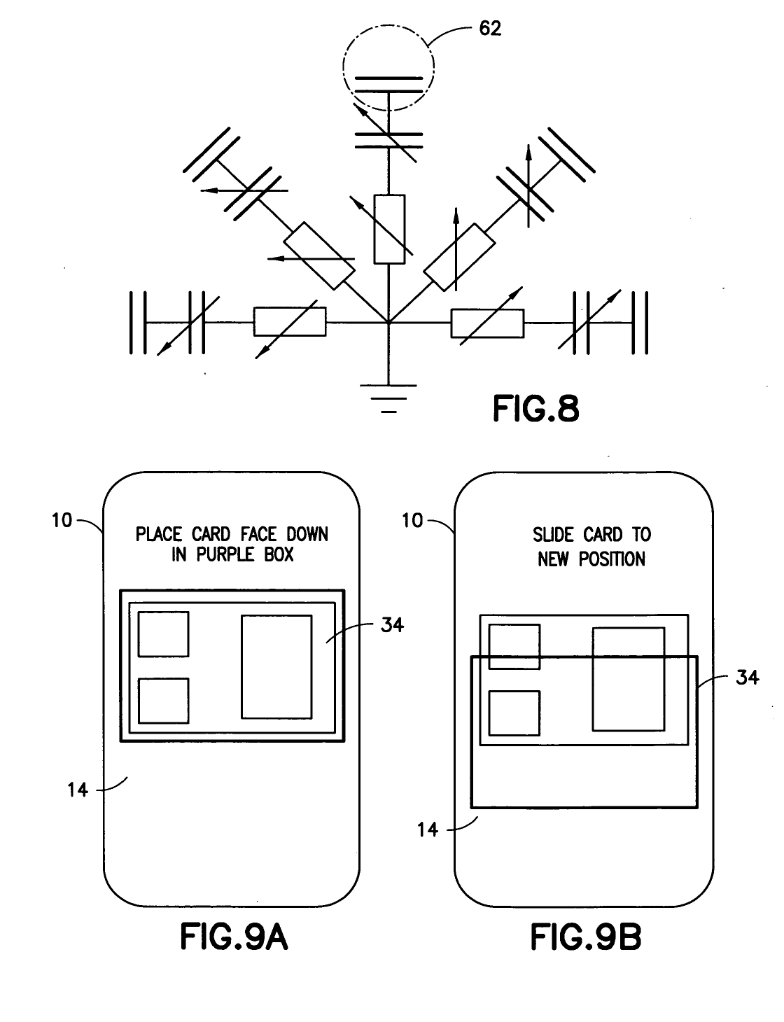

FIG. 8 shows a more complex system with more sensing “nodes”. One of more of the passive electrodes can be used as a reference, while connections to others are modified by the measurand. A capacitor is formed from the touch panel electrode(s) and the RSE electrode as indicated by 62.

An alternative to using reference electrode nodes for alignment is shown in FIGS. 9A and 9B, whereby an application could be used to provide an alignment box on the screen 14 of the mobile device 10, and swiping the device 34 over the screen could confirm the relative positions of the nodes to each (to avoid any erroneous input such as a stray finger). Thus, FIGS. 9A-9B: illustrate a method to reduce the number of reference electrodes.

Active Electrode Design

An alternative embodiment is an active electrode design. Rather than using fixed conducting electrodes with constant dielectric or impedance properties and use the interconnects as the sensing region, the electrode regions themselves become the sensing element. In this embodiment, the electrode area is exposed to the measurand and sensing media in such a way that the impedance or dielectric properties of the electrode changes; changing directly the capacitive coupling of the electrode to the mobile device.

This change in capacitive coupling may also be read by the mobile device touch sensor as a change in the number or location, separation, area, shape or magnitude of the apparent touch points over the measurement period.

As a proof of principle, silver electrodes were painted onto an acetate 70 in the three different configurations 64, 66, 68 shown diagrammatically in FIG. 10 and pictured in FIG. 11. The acetate was placed on top of a capacitive touch panel 32, and a finger was swiped from left to right across the panel. In FIG. 10 there are diagrammatic layouts of three different designs of painted silver electrode, where the circles represent the position where an electrode node with large enough area to be detected is located and the squares represent the position where the finger is placed on the conductive track. FIG. 11 is a picture of the painted silver tracks on an acetate, placed on top of a capacitive touch panel. When no finger is in contact with the painted silver it can be considered as a floating electrode and any change in capacitance does not exceed the pre-programed threshold. When this was tried with a touch panel the silver traces were effectively invisible to the touch panel, and no output signal was shown from the panel. However, when a finger is in contact with one section of the conductive silver such as at ground pads 58, all of the positions where the electrode area is large enough to sufficiently change the coupled charge to the receiver electrode (exceed the pre-programmed threshold) are registered as a finger touch (including the position of the finger). FIGS. 10A-10C show the outputs of the three different electrode configurations from the capacitive touch panel when a finger is in contact with the conductor and the substrate, and the acetate is swiped a short distance from left to right. FIG. 10A is for only electrode 64. The touchscreen 14 outputs signals equivalent to having been touched at the four locations 64A, 64B, 64C and 64D. FIG. 10B is for only electrode 66. The touchscreen 14 outputs signals equivalent to having been touched at the two locations 66B and 66D. FIG. 10C is for only electrode 68. The relative position of the inputs remains constant and corresponds to the position of the painted nodes. The touchscreen 14 outputs signals equivalent to having been touched at the three locations 68B, 68C and 68D and swiped across.

The relative position data could, therefore, be used by a computer program (“App”) to decode what the inputs mean. Referring also to FIGS. 11A-11C, an example will be described. FIG. 11A shows three simulated touch events 70A, 70B, 70C which the touch input device 32 senses when the device 34 is located on the touch screen 14. The software 28 may be configured to identify the type of device 34 based upon the location of these three simulated touch points. The energy used to create the three simulated touch events 70A, 70B, 70C may be turned OFF after identification is completed, but in this example it is kept ON to help with the explanation. In FIG. 11A the attached device 34 does not output any signal for the active component 42 (such as sensor). FIG. 11B shows when the active component 42 causes a first signal from the device 34 which causes a simulated touch event 72 on the touch input device 32. FIG. 11C shows when the active component 42 causes a second different signal from the device 34 which causes a simulated touch event 74 on the touch input device 32. Based upon the location (and perhaps duration) of the simulated touch events 72 or 74 (or both), the controller 20 including the software 28 may be configured to act upon this input information in a predetermined manner or otherwise. Thus, the system allows the touch screen to be used as an I/O port for a device, and not only as a user touchscreen for user touch. The input signal varies with time from FIG. 11A (no active component signal; only reference signals) to FIG. 11B and/or FIG. 11C.

Advantages of features described herein include:
Lack of requirement for standards compatibility.
Very broad range of potential sensing applications.
Portability.
Extremely high volume of potential sensors (TIDs) already established in the market.
Fabrication is low cost compared to other sensors (NFC, RFID) and suitable for roll-to-roll fabrication techniques.
Compatible with any device with a capacitive touch screen and does not require a high end device with a dedicated sensor reader.

An example embodiment may be provided in an apparatus comprising a capacitive touch input device (TID); and a controller connected to the capacitive touch input device, where the controller is configured to process a user touch signal from the capacitive touch input device, and where the controller is configured to process a non-touch signal from the capacitive touch input device generated by an electrical coupling of a device to the capacitive touch input device, where the non-touch signal is a variable signal.

The capacitive touch input device may be a touchscreen. The controller may be configured to determine when the device is located on the capacitive touch input device. The controller may be configured to process the non-touch signal from the capacitive touch input device generated by the electrical coupling of the device to the capacitive touch input device which comprises a wireless coupling. The non-touch signal may comprise at least one of: a change in a number of measurable touch locations on the capacitive touch input device; a change in a separation of two or more touch locations on the capacitive touch input device; a change in a location of one or more touch locations on the capacitive touch input device during a period of the measurement; a change in a capacitive coupling between the capacitive touch input device and the device in one or more locations caused either by a change in dielectric properties or impedance of circuits of the device; and a change in a capacitive coupling between the capacitive touch input device and the device caused by a change in area or shape of a region affected by the measurand on the device. The controller may be configured to determine an alignment of the device on the capacitive touch input device. The electrical coupling may be a capacitive coupling, and where the controller is configured to process the non-touch signal based upon a change in the capacitive coupling. The controller may be configured to process the non-touch signal based upon a change in at least one of a number, location, separation, area, shape or magnitude of artificially created touch point(s) over a measurement period on the capacitive touch input device. The apparatus may comprise means for electrically coupling the device to the apparatus using the capacitive touch input device as an input for the device to the apparatus. The apparatus may further comprise an accessory device connected to the apparatus as the device, where the accessory device comprises at least one sensor.

Referring also to FIG. 12, an example method may comprise providing an apparatus with a capacitive touch input device (TID) as indicated by block 76; and connecting a controller to the capacitive touch input device, where the controller is configured to process a user touch signal from the capacitive touch input device, and where the controller is configured to process a non-touch signal from the capacitive touch input device based upon an electrical coupling of a device to the capacitive touch input device, and where the controller is configured to process the non-touch signal as the signal varies as indicated by block 78.

Providing the apparatus with the capacitive touch input device may comprise providing the capacitive touch input device as a touchscreen. The method may further comprise the controller determining, based upon the non-touch signal from the capacitive touch input device, when the device is located on the capacitive touch input device. The method may further comprise providing the controller configured to process the non-touch signal based upon at least one of a change in a number of measurable touch locations on the capacitive touch input device; a change in a separation of two or more touch locations on the capacitive touch input device; a change in a location of one or more touch locations on the capacitive touch input device during a period of the measurement; a change in a capacitive coupling between the capacitive touch input device and the device in one or more locations caused either by a change in a dielectric properties or impedance of circuits of the device; and a change in a capacitive coupling between the capacitive touch input device and the device caused by a change in area or shape of a region affected by the measurand on the device.

In another example embodiment, a non-transitory program storage device (such as memory 24 for example) readable by a machine may be provided, tangibly embodying a program of instructions executable by the machine for performing operations, the operations comprising processing a first user touch signal from a capacitive touch input device (TID) a first way; and processing a second device generated signal from the capacitive touch input device a second different way, where the processing of the second signal is configured to process a change in the second signal. It may further comprise an operation of determining when a signal from the capacitive touch input device is the first signal or the second signal based upon a determination if a device is coupled to the capacitive touch input device.

Referring also to FIG. 13, an example method may comprise connecting an accessory device to an apparatus as indicated by block 80, where the apparatus comprises a capacitive touch input device (TID), where the accessory device is located on the capacitive touch input device; and generating a signal from the capacitive touch input device based upon a wireless signal being generated by the accessory device, where the wireless signal varies over time as indicated by block 82.

The method may further comprise a controller of the apparatus processing the signal based upon at least one of a change in a number of measurable touch locations on the capacitive touch input device; a change in a separation of two or more touch locations on the capacitive touch input device; a change in a location of one or more touch locations on the capacitive touch input device during a period of the measurement; a change in a capacitive coupling between the capacitive touch input device and the device in one or more locations caused either by a change in a dielectric properties or impedance of circuits of the device; and a change in a capacitive coupling between the capacitive touch input device and the device caused by a change in area or shape of a region affected by the measurand on the device. The method may further comprise determining an alignment of the accessory device on the capacitive touch input device. The wireless signal may comprise a capacitive coupling of the accessory device to the capacitive touch input device. The method may further comprise processing the signal based upon a change in at least one of a number, location, separation, area, shape or magnitude of artificially created touch point(s) over a measurement period on the capacitive touch input device.

An example embodiment may be provided in an apparatus comprising a body; a plurality of electrodes on the body, where the body is configured to be placed on a capacitive touch input device (TID) to locate the electrodes against the capacitive touch input device; and electrical circuitry on the body which is connected to at least one of the electrodes, where the apparatus is configured to send a signal from the electrical circuitry, which is variable in time, to the capacitive touch input device by a wireless coupling of the at least one electrode with the capacitive touch input device. The wireless coupling is a capacitive coupling. The electrical circuitry comprises at least one sensor for sensing a measurand. The electrical circuitry comprises means for powering the apparatus by a power wireless coupling with an apparatus having the capacitive touch input device. With features as described herein, an apparatus may be provided which has a pattern which is changing when it is detecting a variable liquid, temperature, etc. This changed pattern may be read by a touch panel.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. An apparatus comprising:
a capacitive touch input device (TID); and
a controller connected to the capacitive touch input device, where the controller is configured to process a user touch signal from the capacitive touch input device, and where the controller is configured to process a non-touch signal from the capacitive touch input device generated by an electrical coupling of a device to the capacitive touch input device, where the non-touch signal is a variable signal.

2. An apparatus as in claim 1 where the capacitive touch input device is a touchscreen.

3. An apparatus as in claim 1 where the controller is configured to determine when the device is located on the capacitive touch input device.

4. An apparatus as in claim 1 where the controller is configured to process the non-touch signal from the capacitive touch input device generated by the electrical coupling of the device to the capacitive touch input device which comprises a wireless coupling.

5. An apparatus as in claim 1 where the non-touch signal comprises at least one of:
a change in a number of measurable touch locations on the capacitive touch input device;
a change in a separation or two or more touch locations on the capacitive touch input device;
a change in a location of one or more touch locations on the capacitive touch input device during a period of the measurement;
a change in a capacitive coupling between the capacitive touch input device and the device in one or more locations caused either by a change in a dielectric properties or impedance of circuits of the device; and
a change in a capacitive coupling between the capacitive touch input device and the device caused by a change in area or shape of a region affected by the measurand on the device.

6. An apparatus as in claim 1 where the controller is configured to determine an alignment of the device on the capacitive touch input device.

7. An apparatus as in claim 1 where the electrical coupling is a capacitive coupling, and where the controller is configured to process the non-touch signal based upon a change in the capacitive coupling.

8. An apparatus as in claim 1 where the controller is configured to process the non-touch signal based upon a change in at least one of a number, location, separation, area, shape or magnitude of artificially created touch point(s) over a measurement period on the capacitive touch input device.

9. An apparatus as in claim 1 where the apparatus comprises means for electrically coupling the device to the apparatus using the capacitive touch input device as an input for the device to the apparatus.

10. An apparatus as in claim 1 further comprising an accessory device connected to the apparatus as the device, where the accessory device comprises at least one sensor.

11. A method comprising:
providing an apparatus with a capacitive touch input device (TID); and
connecting a controller to the capacitive touch input device, where the controller is configured to process a user touch signal from the capacitive touch input device, and where the controller is configured to process a non-touch signal from the capacitive touch input device based upon an electrical coupling of a device to the capacitive touch input device, and where the controller is configured to process the non-touch signal as the signal varies.

12. A method as in claim 11 where providing the apparatus with the capacitive touch input device comprises providing the capacitive touch input device as a touchscreen.

13. A method as in claim 11 further comprising the controller determining, based upon the non-touch signal from the capacitive touch input device, when the device is located on the capacitive touch input device.

14. A method as in claim 11 further comprising providing the controller configured to process the non-touch signal based upon at least one of:
a change in a number of measurable touch locations on the capacitive touch input device;
a change in a separation of two or more touch locations on the capacitive touch input device;
a change in a location of one or more touch locations on the capacitive touch input device during a period of the measurement;
a change in a capacitive coupling between the capacitive touch input device and the device in one or more locations caused either by a change in a dielectric properties or impedance of circuits of the device; and
a change in a capacitive coupling between the capacitive touch input device and the device caused by a change in area or shape of a region affected by the measurand on the device.

15. An apparatus comprising:
a body;
a plurality of electrodes on the body, where the body is configured to be placed on a capacitive touch input device (TID) to locate the electrodes against the capacitive touch input device; and
electrical circuitry on the body which is connected to at least one of the electrodes,
where the apparatus is configured to send a signal from the electrical circuitry, which is variable in time, to the capacitive touch input device by a wireless coupling of the at least one electrode with the capacitive touch input device.

16. An apparatus as in claim 15 where the wireless coupling is a capacitive coupling.

17. An apparatus as in claim 15 where the electrical circuitry comprises at least one sensor for sensing a measurand.

18. An apparatus as in claim 15 where the electrical circuitry comprises means for powering the apparatus by a power wireless coupling with an apparatus having the capacitive touch input device.
